(19) United States
(12) Patent Application Publication
(10) Pub. No.: US 2025/0292720 A1
(43) Pub. Date: Sep. 18, 2025

(54) DISPLAY DEVICE

(71) Applicant: Innolux Corporation, Miaoli County (TW)

(72) Inventors: Cheng-Min Wu, Miaoli County (TW); Ming-Jhih Chen, Miaoli County (TW); Heng-Cheng Song, Miaoli County (TW)

(73) Assignee: Innolux Corporation, Miaoli County (TW)

(21) Appl. No.: 19/052,317

(22) Filed: Feb. 13, 2025

(30) Foreign Application Priority Data
Mar. 18, 2024 (CN) 202410308435.6

(51) Int. Cl. G09G 3/20

(52) U.S. Cl. CPC G09G 3/2092; G09G 2300/0426; G09G 2310/08; G09G 2320/08; G09G 2330/04

(57) ABSTRACT

A display device includes a substrate, a first signal line, a second signal line, a third signal line, and isolation elements. The substrate has a first area and a second area surrounding the first area. The first, second, and third signal lines are disposed on the substrate and transmit a first signal, a second signal, and a third signal. The isolation elements are disposed in the first area. The first and second signals respectively have a first turn-on time period. The third signal has a second turn-on time period different from the first turn-on time period. In the second area, the third signal line is disposed between the first and second signal lines. In the first area, the second signal line is disposed between the first and third signal lines. One of the isolation elements is disposed between the second signal line and a part of the third signal line.

### CROSS-REFERENCE TO RELATED APPLICATION

This application claims the priority benefit of China application serial no. 202410308435.6, filed on Mar. 18, 2024. The entirety of the above-mentioned patent application is hereby incorporated by reference herein and made a part of this specification.

### BACKGROUND

### Technical Field

The disclosure relates to a device, and in particular to a display device.

### Description of Related Art

A hole frame of a general hole in display (HID) device is designed to be as small as possible, so a routing space of a hole border area passing through the hole frame is also relatively small. In other words, a routing spacing of signal lines of a display panel in the hole border area of the hole frame is smaller than the routing spacing in a display area. As a result, severe signal coupling interference occurs between multiple signal lines in the hole border area of the hole frame due to the routing spacing being too small, thereby affecting the display quality.

### SUMMARY

The disclosure provides a display device, which can provide a good display effect.

According to an embodiment of the disclosure, a display device includes a substrate, a first signal line, a second signal line, a third signal line, and multiple isolation elements. The substrate has a first area and a second area. The second area surrounds the first area. The first signal line, the second signal line, and the third signal line are disposed on the substrate. The first signal line, the second signal line, and the third signal line respectively extend from the second area to the first area. The first signal line, the second signal line, and the third signal line are configured to transmit a first data signal, a second data signal, and a third data signal in a time-sharing manner. The isolation elements are disposed in the first area. The first signal and the second signal respectively have a first turn-on time period, and the third signal has a second turn-on time period. The first turn-on time period is different from the second turn-on time period. In the second area, the third signal line is disposed between the first signal line and the second signal line. In the first area, the second signal line is disposed between the first signal line and the third signal line. One of the isolation elements is disposed between the second signal line and a part of the third signal line.

Based on the above, the display device of the disclosure can effectively reduce signal coupling interference between the signal lines through the configuration design of the signal lines and the setting of the isolation elements.

In order for the features and advantages of the disclosure to be more comprehensible, the following specific embodiments are described in detail in conjunction with the drawings.

### BRIEF DESCRIPTION OF THE DRAWINGS

FIG. 1 is a partially enlarged schematic diagram of a display device according to an embodiment of the disclosure.

FIG. 2 is a partially enlarged schematic diagram of a display device according to another embodiment of the disclosure.

FIG. 3A and FIG. 3B are line width schematic diagrams of a signal line according to an embodiment of the disclosure.

FIG. 4 is a signal timing diagram according to an embodiment of the disclosure.

FIG. 5 is a schematic diagram of a display device according to another embodiment of the disclosure.

### DESCRIPTION OF THE EMBODIMENTS

Reference will now be made in detail to the exemplary embodiments of the disclosure, examples of the exemplary embodiments are illustrated in the drawings. Wherever possible, the same reference numerals are used in the drawings and the description to refer to the same or similar parts.

Throughout the specification and the appended claims of the disclosure, certain terms are used to refer to specific components. It should be understood by persons skilled in the art that electronic device manufacturers may refer to the same component by different names. The disclosure does not intend to distinguish between component with the same function but different names. In the following specification and claims, words such as “containing” and “comprising” are open-ended words, so the words should be interpreted as “including but not limited to . . . ”.

In some embodiments of the disclosure, terms related to bonding and connection, such as “coupling” and “interconnection”, unless otherwise defined, may mean that two structures are in direct contact, or may also mean that the two structures are not in direct contact, wherein there is another structure disposed between the two structures. Also, the terms related to bonding and connection may also include the case where the two structures are both movable or the two structures are both fixed. In addition, the term “coupling” includes any direct and indirect means of electrical connection.

Ordinal numbers such as “first” and “second” used in the specification and the claims are used to modify components, and the ordinal numbers do not imply and represent that the components have any previous ordinal numbers, nor do they represent the sequence of a certain component and another component or the sequence of a manufacturing method. The use of the ordinal numbers is only used to clearly distinguish between a component with a certain name and another component with the same name. The claims and the specification may not use the same terms, whereby a first member in the specification may be a second member in the claims. It should be noted that in the following embodiments, the technical features of several different embodiments may be replaced, reorganized, and mixed to complete other embodiments without departing from the spirit of the disclosure.

The display device mentioned in the disclosure may include a virtual reality device, an augmented reality device, a head-up display device, a transparent display device, a sensing device, or a splicing device, but not limited thereto. The display device may be a bendable or flexible electronic device. The display device may be a non-self-luminous display device or a self-luminous display device. The sensing device may be a sensing device that senses capacitance, light rays, heat energy, or ultrasonic waves, but not limited thereto. The display device may include, for example, electronic elements such as a passive element and an active element, such as a capacitor, a resistor, an inductor, a diode, and a transistor. The diode may include a light emitting diode or a photodiode. The light emitting diode may include, for example, an inorganic light emitting diode, an organic light emitting diode (OLED), a mini LED, a micro LED, or a quantum dot LED, but not limited thereto. The splicing device may be, for example, a display splicing device, but not limited thereto. It should be noted that the display device may be any permutation and combination of the above, but not limited thereto.

In the disclosure, the measurement manner of distance, length, width, and thickness may be by adopting an optical microscope, and distance, length, width, and thickness may be obtained by measuring a cross-sectional image in an electron microscope, but not limited thereto. If a first value is equal to a second value, it implies that there may be an error of about 10% between the first value and the second value; if a first direction is perpendicular to a second direction, an angle between the first direction and the second direction may be between 80 degrees and 100 degrees; and if the first direction is parallel to the second direction, the angle between the first direction and the second direction may be between 0 degrees and 10 degrees.

In addition, relative terms, such as “lower” or “bottom” and “upper” or “top”, may be used in the embodiments to describe the relative relationship between an element and another element in the drawings. It will be understood that if a device in a drawing is flipped upside down, elements described as being on the “lower” side will be then become elements on the “upper” side. When a corresponding member (for example, a film layer or an area) is referred to as being “on another member”, the member may be directly on the other member or there may be another member between the two. On the other hand, when a member is referred to as being “directly on another member”, there is no member between the two. In addition, when a member is referred to as being “on another member”, there is a vertical relationship between the two in the top view direction, and the member may be above or below the other member. The vertical relationship depends on the orientation of the device.

It should be noted that without departing from the spirit of the disclosure, features in several different embodiments may be replaced, reorganized, and mixed to complete other embodiments.

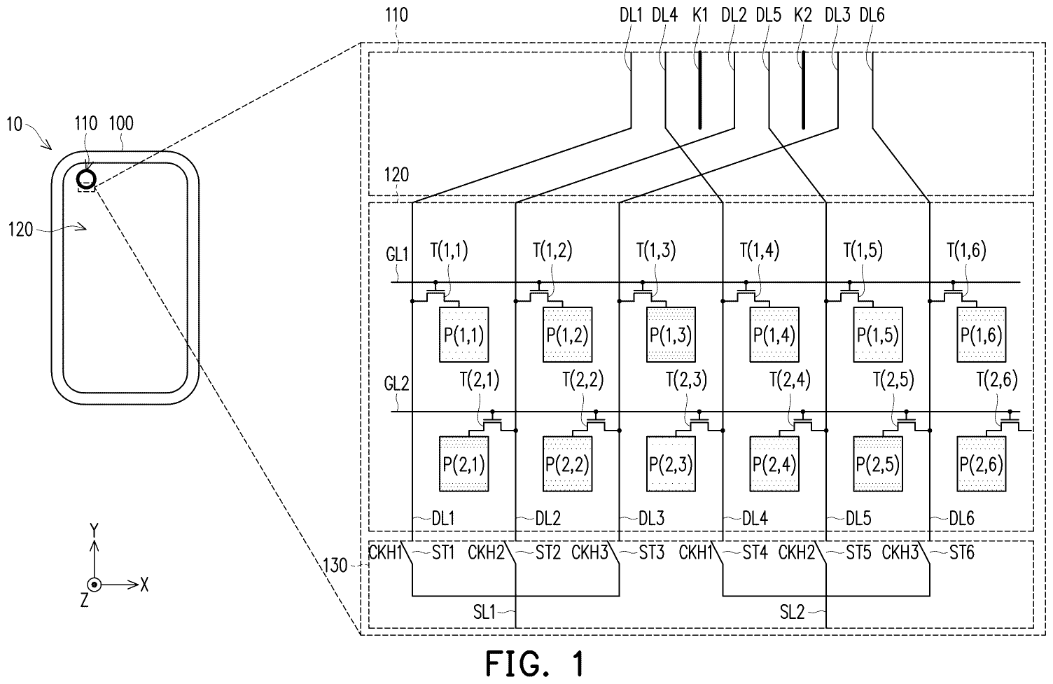

FIG. 1 is a partially enlarged schematic diagram of a display device according to an embodiment of the disclosure. Referring to FIG. 1, a display device 10 includes a substrate 100. The substrate 100 includes a first area 110, a second area 120, and a third area 130, wherein the substrate 100 may be forming by stacking multiple metal layers (for example, gold, silver, copper, aluminum, chromium, platinum, tin, alloys thereof, or combinations thereof) and multiple insulating layers (for example, silicon dioxide, silicon nitride, silicon oxynitride, polyimide, polyester, etc., or mixed materials thereof). The second area 120 surrounds the first area 110. In the embodiment, the first area 110 may include a hole and a hole border area, and the second area 120 may include a pixel area (that is, a display area or an active area (AA) of a panel). In addition, the third area 130 includes a peripheral area, which may include, for example, a peripheral area provided with a driving circuit, a bonding pad, and a test circuit. In an embodiment, the third area may surround the second area, but the disclosure is not limited thereto. Adjacent areas of the first area 110 and the second area 120 may be enlarged as shown on the right side of FIG. 1.

In the embodiment, the second area 120 may include multiple sub-pixel units P(1,1) to P(2,6) arranged in an array, multiple switching units T(1,1) to T(2,6), multiple signal lines DL1 to DL6, and multiple gate lines GL1 and GL2. The switching units T(1,1) to T(2,6) may respectively be N-type transistors or P-type transistors. It should be noted that the second area 120 only represents the sub-pixel configuration relationship of a part of the substrate 100, and the number of sub-pixel units, the number of switching units, the number of signal lines, and the number of gate lines of the substrate 100 are not limited to as shown in FIG. 1.

In the embodiment, the signal line DL1 is electrically connected to a part of the sub-pixel units P(1,1) to P(2,6), the signal line DL2 is electrically connected to another part of the sub-pixel units P(1,1) to P(2,6), and the signal line DL3 is electrically connected to yet another part of the sub-pixel units P(1,1) to P(2,6). By analogy, the signal lines DL4 to DL6 are respectively electrically connected to different sub-pixel units. In the embodiment, the sub-pixel units P(1,1) to P(2,6) may include sub-pixels of different colors, such as red sub-pixels, green sub-pixels, blue sub-pixels, and white sub-pixels, but the disclosure is not limited thereto. Furthermore, a part of the sub-pixels electrically connected to the signal line DL2 and another part of the sub-pixels electrically connected to the signal line DL4 may be sub-pixels of the same color.

Specifically, first terminals of the switching units T(1,1) to T(2,6) are respectively coupled to the sub-pixel units P(1,1) to P(2,6). Control terminals of the switching units T(1,1) to T(1,6) are coupled to the gate line GL1. Control terminals of the switching units T(2,1) to T(2,6) are coupled to the gate line GL2. The gate line GL1 and the gate line GL2 may respectively receive different gate control signals and enable turn-on time intervals (that is, high-level time) of the switching units T(1,1) to T(1,6) and the switching units T(2,1) to T(2,6) to not overlap. Alternatively, in another embodiment, the turn-on time intervals (that is, high-level time) of the switching units T(2,1) to T(2,6) at least partially overlap. A second terminal of the switching unit T(1,1) is coupled to the signal line DL1. Second terminals of the switching unit T(1,2) and the switching unit T(2,1) are coupled to the signal line DL2. Second terminals of the switching unit T(1,3) and the switching unit T(2,2) are coupled to the signal line DL3. Second terminals of the switching unit T(1,4) and the switching unit T(2,3) are coupled to the signal line DL4. Second terminals of the switching unit T(1,5) and the switching unit T(2,4) are coupled to the signal line DL5. Second terminals of the switching unit T(1,6) and the switching unit T(2,5) are coupled to the signal line DL6. A second terminal of the switching unit T(2,6) may be coupled to the next signal line (not shown in the drawing). However, the electrical connection manner between the sub-pixel units and the signal lines of the disclosure is not limited to as shown in FIG. 1. In the embodiment, the sub-pixel units P(1,1), P(2,3), and P(1,5) may be red sub-pixels. The sub-pixel units P(2,1), P(1,3), and P(2,5) may be blue sub-pixels. The sub-pixel units P(1,2), P(2,2), P(1,4), P(2,4), P(1,6), and P(2,6) may be green sub-pixels. In this regard, the signal line DL2 and the signal line DL3 may be respectively electrically connected to the green sub-pixel unit P(1,2) and sub-pixel unit P(2,2), and so on.

In addition, in another embodiment, the sub-pixel units P(1,1), P(1,2), and P(1,3) may also sequentially be red sub-pixels, green sub-pixels, and blue sub-pixels, and the sub-pixel units P(2,1), P(2,2), and P(2,3) may also sequentially be red sub-pixels, green sub-pixels, and blue sub-pixels, but the disclosure is not limited thereto. In addition, in the arrangement manner of the red sub-pixels, the green sub-pixels, and the blue sub-pixels, the second terminals of the sub-pixels in the same row may be respectively electrically connected to the signal line on the left (for example, the sub-pixel units P(1,1) and P(2,1) of FIG. 1 may be electrically connected to the signal line DL1).

In the embodiment, the third area 130 (that is, the peripheral area below the second area 120 or outside the active area of the panel) of the substrate 100 may also include multiple switching units ST1 to ST6. The switching units ST1 to ST6 may form a de-multiplexer (DMux) circuit. A display driver (for example, an integrated circuit or a chip) of the display device 10 may be electrically connected to the signal lines DL1 to DL3 through the signal line SL1 and the switching units ST1 to ST3. The display driver of the display device 10 may be electrically connected to the signal lines DL4 to DL6 through the signal line SL2 and the switching units ST4 to ST6, but the embodiment is not limited thereto. The switching units ST1 to ST6 may respectively be N-type transistors or P-type transistors. The switching unit ST1 and the switching unit ST4 may receive the same clock signal CKH1. The switching unit ST2 and the switching unit ST5 may receive the same clock signal CKH2. The switching unit ST3 and the switching unit ST6 may receive the same clock signal CKH3. The switching units ST1 to ST3 may be sequentially conducted at different times according to the clock signals CKH1 to CKH3 to provide different data signals to the signal lines DL1 to DL3. The switching units ST4 to ST6 may be sequentially conducted at different times according to the clock signals CKH1 to CKH3 to provide different data signals to the signal lines DL4 to DL6.

In the embodiment, the signal lines DL1 to DL6 extend from the second area 120 to the first area 110. Since the routing space of the first area 110 is smaller than the routing space of the second area 120, in order to reduce signal coupling interference between the signal lines DL1 to DL6, the signal lines DL1 to DL6 are re-wired during the process of extending from the second area 120 to the first area 110, and an isolation element K1 and an isolation element K2 are disposed, wherein the isolation element K1 and the isolation element K2 may include conductive elements, such as gold, silver, copper, aluminum, chromium, platinum, tin, alloys thereof, combinations thereof, or insulating elements, such as silicon dioxide, silicon nitride, silicon oxynitride, polyimide, polyester, etc., or mixed materials thereof, but the disclosure is not limited thereto.

In the embodiment, as shown in FIG. 1, the routing sequence of the signal lines DL1 to DL6 may be changed in the first area 110. For example, in the second area 120 of the substrate 100, the signal line DL2 is disposed between the signal line DL1 and the signal line DL4, and in the first area 110 of the substrate 100, after the routing sequence is changed, the signal line DL4 may be disposed between the signal line DL1 and the signal line DL2. In the first area 110, the signal lines DL1 and DL4 are disposed on a side of the isolation element K1, and the signal lines DL2 and DL5 are disposed on the other side of the isolation element K1. The signal lines DL2 and DL5 are disposed on a side of the isolation element K2, and the signal lines DL3 and DL6 are disposed on the other side of the isolation element K2. Specifically, in the first area 110 of the substrate 100, the signal line DL1 and the signal line DL4 writing display data based on the first clock signal CKH1 may be disposed adjacent to each other, and the signal line DL2 writing display data based on the second clock signal CKH2 (different from the signal line DL1 and the signal line DL4) can reduce signal coupling interference with the signal line DL4 via the isolation element K1. By analogy, in the first area 110 of the substrate 100, multiple signal lines controlled by the same clock signal may be adjacently disposed, and signal isolation between two adjacent signal lines controlled by different clock signals may be implemented through the isolation element. Therefore, the signal lines DL1 to DL6 can have lower signal coupling interference in the first area 110 of the substrate 100.

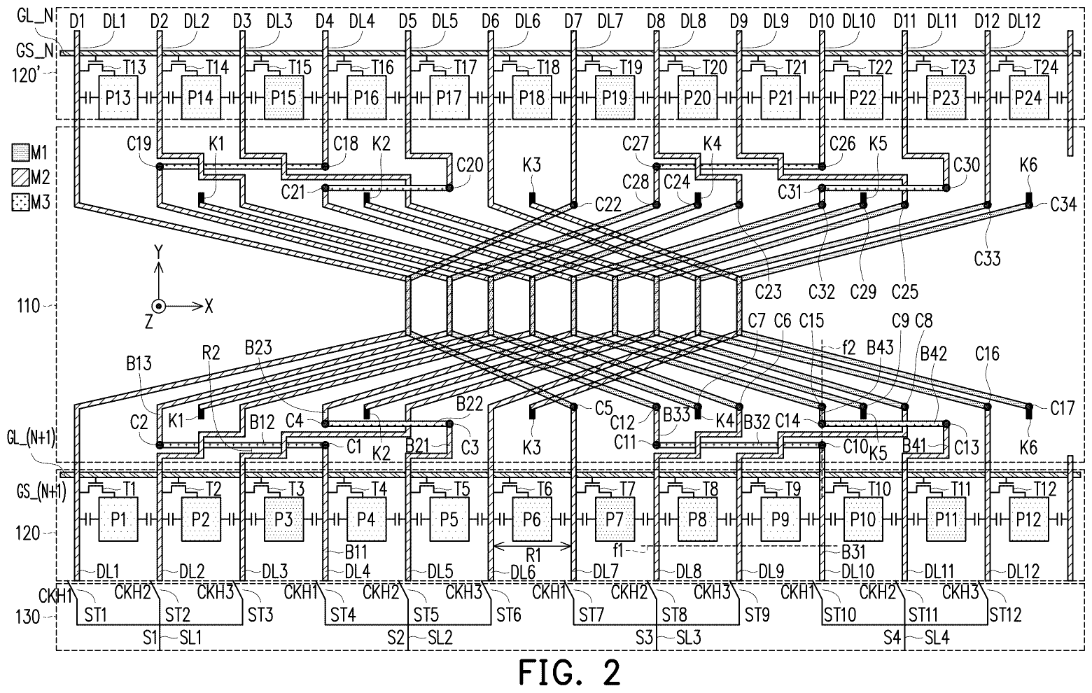

FIG. 2 is a partially enlarged schematic diagram of a display device according to another embodiment of the disclosure. Referring to FIG. 2, FIG. 2 is used to illustrate the routing configuration manner in which the signal lines of FIG. 1 extend to the first area 110 via the second area 120, and then extend to a second area 120′ via the first area 110. Referring to FIG. 2, the signal lines DL1 to DL12 may extend from a side of the second area 120 to the other side of another second area 120′ via the first area 110. In an embodiment, the signal lines disposed in the first area 110 include two adjacent signal lines with a minimum separation distance R2 (for example, a distance between signal lines of two adjacent sub-pixels), and the signal lines disposed in the second area 120 include two adjacent signal lines with a minimum separation distance R1 (for example, a distance between two adjacent signal lines in a third metal layer), wherein the minimum separation distance R2 is smaller than the minimum separation distance R1, but the disclosure is not limited thereto.

In the embodiment, the signal lines DL1 to DL12 are respectively electrically connected to one terminals of the switching units T1 to T12 in the second area 120, and the other terminals of the switching units T1 to T12 are respectively electrically connected to the sub-pixel units P1 to P12. Control terminals of the switching units T1 to T12 are electrically connected to a gate line GL_(N+1), where N is a positive integer. The signal lines DL1 to DL12 may also be respectively electrically connected to the switching units ST1 to ST12 in the third area 130 (that is, the peripheral area below the second area 120 or outside the active area of the panel). In the embodiment, the signal lines DL1 to DL12 are respectively electrically connected to one terminals of the switching units T13 to T24 in the second area 120′, and the other terminals of the switching units T13 to T24 are respectively electrically connected to the sub-pixel units P13 to P24. Control terminals of the switching units T13 to T24 are electrically connected to a gate line GL_N. The switching units T1 to T24 may respectively be N-type transistors or P-type transistors.

In the embodiment, the sub-pixel units P1, P5, P9, P13, P17, and P21 may be, for example, red sub-pixel units. The sub-pixel units P2, P4, P6, P8, P10, P12, P14, P16, P18, P20, P22, and P24 may be, for example, green sub-pixel units. The sub-pixel units P3, P7, P11, P15, P19, and P23 may be, for example, blue sub-pixel units. In another embodiment, the sub-pixel units P1, P4, P7, P10, P13, P16, P19, and P22 may be, for example, red sub-pixel units. The sub-pixel units P2, P5, P8, P11, P14, P17, P20, and P23 may be, for example, green sub-pixel units. The sub-pixel units P3, P6, P9, P12, P15, P18, P21, and P24 may be, for example, blue sub-pixel units. In other words, the sub-pixel units in the same column may be arranged in RGB, but the disclosure is not limited thereto.

In the embodiment, the switching units ST1 to ST3 may also be electrically connected to the same signal line SL1 to receive the same data signal S1. The switching units ST4 to ST6 may also be electrically connected to the same signal line SL2 to receive the same data signal S2. The switching units ST7 to ST9 may also be electrically connected to the same signal line SL3 to receive the same data signal S3. The switching units ST10 to ST12 may also be electrically connected to the same signal line SL4 to receive the same data signal S4. In the embodiment, switching units ST1, ST4, ST7, and ST10 may receive the same clock signal CKH1. The switching units ST2, ST5, ST8, and ST11 may receive the same clock signal CKH2. The switching units ST3, ST6, ST9, and ST12 may receive the same clock signal CKH3. The switching units ST1 to ST12 may respectively be N-type transistors or P-type transistors.

In an embodiment of the disclosure, the substrate further includes a composite layer. The composite layer may include, for example, a first metal layer M1, a second metal layer M2, and a third metal layer M3, wherein the second metal layer M2 may be disposed between the first metal layer M1 and the third metal layer M3, but the disclosure is not limited thereto, and multiple insulating layers and multiple through holes communicating two adjacent metal layers may also be disposed between any two adjacent metal layers. The signal lines DL4, DL5, and DL6 to DL12 may respectively extend to different metal layers via the corresponding through holes, re-wiring then enables the setting sequence of a part of the signal lines DL1 to DL12 in the first area 110 to be different from the setting sequence of the signal lines DL1 to DL12 in the second areas 120 and 120′, the signal lines DL1 to DL12 may then extend to another metal layer via another through hole, and the setting sequence of the signal lines DL1 to DL12 is restored, but the disclosure is not limited thereto. In addition, the gate line GL_N and the gate line GL_(N+1) may be formed in the second metal layer M2, but the disclosure is not limited thereto.

For example, on a side of the first area 110 close to the second area 120, the signal lines DL1 to DL6 may be, for example, first disposed in the second metal layer M2 of the substrate, wherein the signal lines DL4 and DL5 may respectively extend to the third metal layer M3 via through holes C1 and C3, and be then respectively transferred to the second metal layer M2 via through holes C2 and C4. On a side of the first area 110 close to the second area 120′, the signal lines DL4 and DL5 may respectively extend to the third metal layer M3 via through holes C19 and C21, and be then respectively transferred to the second metal layer M2 via through holes C18 and C20, but he disclosure not limited thereto. The signal lines DL1 to DL3 and DL6 may all be disposed in the second metal layer M2 in the first area 110 and the second area 120, but the disclosure is not limited thereto. It should be noted that the “side of the first area 110 close to the second area 120′” mentioned in the context means taking half of a distance in the Y-axis direction or perpendicular to a gate line direction in the first area 110 as a boundary to divide the first area 110 into two sides in which one side is closer to the second area 120′, but the disclosure is not limited thereto.

On the side of the first area 110 close to the second area 120, the signal lines DL7 to DL12 may be, for example, first disposed in the second metal layer M2 of the substrate. Then, the signal lines DL_7 to DL_9 and DL12 are respectively transferred to the first metal layer M1 via through holes C5, C6, C8, and C16. Moreover, the signal lines DL10 and DL11 may respectively extend to the third metal layer M3 via through holes C10 and C13, be then respectively transferred to the second metal layer M2 via through holes C11 and C14, and be subsequently respectively transferred to the first metal layer M1 via the through holes C12 and C15, but the disclosure is not limited thereto. On the side of the first area 110 close to the second area 120′, the signal lines DL_7 to DL_9 and DL12 are respectively transferred to the second metal layer M2 via through holes C22, C23, C25, and C33, and the signal lines DL10 and DL11 are respectively transferred to the second metal layer M2 via through holes C28 and C32. Then, the signal lines DL10 and DL11 respectively extend to the third metal layer M3 via through holes C27 and C31, and are then respectively transferred to the second metal layer M2 via through holes C26 and C30.

On the side of the first area 110 close to the second area 120, the signal lines DL4, DL5, DL10, and DL11 respectively include first parts B11, B21, B31, and B41 disposed in the second metal layer M2, second parts B12, B22, B32, and B42 disposed in the third metal layer M3, and third parts B13, B23, B33, and B43 disposed in the second metal layer M2, but the disclosure is not limited thereto. The second parts B12, B22, B32, and B42 of the signal lines DL4, DL5, DL10, and DL11 are respectively connected between the first parts B11, B21, B31, and B41 and the third parts B13, B23, B33, and B43. In another embodiment (not shown), the first parts Bl1, B21, B31, and B41 of the signal lines DL4, DL5, DL10, and DL11 may be disposed in the same metal layer of the substrate 100 as the second parts B12, B22, B32, and B42 of the signal lines DL4, DL5, DL10, and DL11. The second parts B12, B22, B32, and B42 of the signal lines DL4, DL5, DL10, and DL11 may be disposed in the same or different metal layers of the substrate 100 as the third parts B13, B23, B33, and B43 of the signal lines DL4, DL5, DL10, and DL11 according to device requirements. Furthermore, in the top view direction of the substrate 100, the respective second parts B12, B22, B32, and B42 of the signal lines DL4, DL5, DL10, and DL11 may be separated from each other. In an embodiment, an extension direction of a part of the second parts B12, B22, B32, and B42 of the signal lines DL4, DL5, DL10, and DL11 may be respectively perpendicular to an extension direction of the first parts B11, B21, B31, and B41 of the signal lines DL4, DL5, DL10, and DL11 or the third parts B13, B23, B33, and B43 of the signal lines DL4, DL5, DL10, and DL11, but the disclosure is not limited thereto. It should be noted that the “side of the first area 110 close to the second area 120” mentioned in the context means taking half of the distance in the Y-axis direction or perpendicular to the gate line direction in the first area 110 as the boundary to divide the first area 110 into two sides in which one side is closer to the second area 120, but the disclosure is not limited thereto.

Between the first area 110 and the second area 120, the first part B11 of the signal line DL4 extends through the through hole C1 to the second part B12 located in a different metal layer (for example, the third metal layer M3). The second part B12 of the signal line DL4 may pass through at least one signal line (for example, the signal line DL2 and the signal line DL3) in the top view direction, and be then transferred to a different metal layer (for example, the second metal layer M2) through the through hole C2. In this way, the setting sequence (for example, the signal line DL1, the signal line DL4, the signal line DL2, and the signal line DL3) of a part of the signal lines (for example, the signal lines DL1 to DL4) in the first area 110 may be different from the setting sequence (for example, the signal line DL1, the signal line DL2, the signal line DL3, and the signal line DL4) in the second area 120, but the disclosure not limited thereto. Moreover, on the side of the first area 110 close to the second area 120′, the signal line DL4 may extend to the through hole C19 via the second metal layer M2, be transferred to the third metal layer M3 through the through hole C19, and be then transferred to the second metal layer M2 through the through hole C18. The routing configuration manner of the signal line DL4 between the first area 110 and the second area 120′ may be symmetrical to the routing configuration manner on the side of the first area 110 close to the second area 120, so that the signal line DL4 may be disposed between the signal line DL3 and the signal line DL5 again.

In the first area 110, a part of the signal line DL1 and a part of the signal line DL4 may be disposed on the same side of the isolation element K1, and a part of the signal line DL1 and a part of the signal line DL4 may be adjacently disposed.

Between the first area 110 and the second area 120, the first part B21 of the signal line DL5 extends through the through hole C3 to the second part B22 located in a different metal layer (for example, the third metal layer M3). The second part B22 of the signal line DL5 may pass through at least one signal line (for example, the signal line DL3) in the top view direction, and be then transferred to a different metal layer (for example, the second metal layer M2) through the through hole C4. In this way, the setting sequence (for example, the signal lines DL4, DL5, DL3, and DL6) of a part of the signal lines (for example, the signal lines DL3 to DL6) in the first area 110 may be different from the setting sequence (for example, the signal lines DL3, DL4, DL5, and DL6) in the second area 120, but the disclosure is not limited thereto. Moreover, on the side of the first area 110 close to the second area 120′, the signal line DL5 may extend to the through hole C21 via the second metal layer M2, be transferred to the third metal layer M3 through the through hole C21, and be then transferred to the second metal layer M2 through the through hole C20. The routing configuration manner of the signal line DL5 on the side of the first area 110 close to the second area 120′ may be symmetrical to the routing configuration manner on the side of the first area 110 close to the second area 120, so that the signal line DL5 may be disposed between the signal line DL4 and the signal line DL6 again.

In the first area 110, a part of the signal line DL2 and a part of the signal line DL5 may be disposed between the isolation element K1 and the isolation element K2, and a part of the signal line DL2 and a part of the signal line DL5 may be adjacently disposed. On the side of the first area 110 close to the second area 120, the routing path of the signal line DL3 may be bent to be close to the signal line DL6. Moreover, on the side of the first area 110 close to the second area 120′, the routing configuration manner of the signal line DL3 may be symmetrical to the routing configuration manner on the side of the first area 110 close to the second area 120, so that the signal line DL3 may be disposed between the signal line DL2 and the signal line DL4 again.

In the first area 110, a part of the signal line DL3 and a part of the signal line DL6 may be disposed between the isolation element K2 and the isolation element K3, and a part of the signal line DL3 and a part of the signal line DL6 may be adjacently disposed.

Between the first area 110 and the second area 120, the first part B31 of the signal line DL10 extends through the through hole C10 to the second part B32 located in a different metal layer (for example, the third metal layer M3). The second part B32 of the signal line DL10 may pass through at least one signal line (for example, the signal lines DL8 and DL9) in the top view direction, be then transferred to a different metal layer (for example, the second metal layer M2) through the through hole C11, and be then transferred to a different metal layer (for example, the first metal layer M1) through the through hole C11. In this way, the setting sequence (for example, the signal lines DL7, DL10, DL8, and DL9) of a part of the signal lines (for example, the signal lines DL7 to DL10) in the first area 110 may be different from the setting sequence (for example, the signal lines DL7, DL8, DL9, and DL10) in the second area 120, but the disclosure is not limited thereto. Moreover, on the side of the first area 110 close to the second area 120′, the signal line DL10 may extend to the through hole C28 via the first metal layer M1, and be transferred to the second metal layer M2 through the through hole C28. Then, the signal line DL10 may extend to the through hole C27 via the second metal layer M2, and be transferred to the third metal layer M3 through the through hole C27. Then, the signal line DL10 may extend to the through hole C26 through the third metal layer M3, and transferred to the second metal layer M2 through the through hole C26. The routing configuration manner of the signal line DL10 on the side of the first area 110 close to the second area 120′ may be symmetrical to the routing configuration manner on the side of the first area 110 close to the second area 120, so that the signal line DL10 may be disposed between the signal line DL9 and the signal line DL11 again.

In the first area 110, a part of the signal line DL7 and a part of the signal line DL10 may be disposed between the isolation element K3 and the isolation element K4, and a part of the signal line DL7 and a part of the signal line DL10 may be adjacently disposed.

It is worth noting that the signal line DL7 and the signal line DL10 may be, for example, respectively transferred to different metal layers (for example, the third metal layer M3) via different through holes, and wired to above the signal line DL1 and the signal line DL4 in the first area 110, but the disclosure is not limited thereto. In this regard, in the first area 110, a part of the signal line DL1 and a part of the signal line DL7 may overlap in the top view direction, and a part of the signal line DL4 and a part of the signal line DL10 may overlap in the top view direction. On the side of the first area 110 close to the second area 120, the first part B41 of the signal line DL11 extends through the through hole C13 to the second part B42 located in a different metal layer (for example, the third metal layer M3). The second part B42 of the signal line DL11 may pass through at least one signal line (for example, the signal line DL9) in the top view direction, be then transferred to a different metal layer (for example, the second metal layer M2) through the through hole C14, and be then transferred to a different metal layer (for example, the first metal layer M1) through the through hole C15. In this way, the setting sequence (for example, the signal lines DL11, DL9, DL12) of a part of the signal lines (for example, the signal lines DL9 to DL12) in the first area 110 may be different from the setting sequence (for example, the signal line DL9, DL11, DL12) in the second area 120, but the disclosure is not limited thereto. Moreover, on the side of the first area 110 close to the second area 120′, the signal line DL11 may extend to the through hole C32 via the first metal layer M1, and be transferred to the second metal layer M2 through the through hole C32. Then, the signal line DL11 may extend to the through hole C31 via the second metal layer M2, and be transferred to the third metal layer M3 through the through hole C31. Then, the signal line DL11 may extend to the through hole C30 via the third metal layer M3, and be transferred to the second metal layer M2 through the through hole C30. The routing configuration manner of the signal line DL11 on the side of the first area 110 close to the second area 120′ may be symmetrical to the routing configuration manner on the side of the first area 110 close to the second area 120, so that the signal line DL11 may be disposed between the signal line DL10 and the signal line DL12 again.

In the first area 110, a part of the signal line DL8 and a part of the signal line DL11 may be disposed between the isolation element K4 and the isolation element K5, and a part of the signal line DL8 and a part of the signal line DL11 may be adjacently disposed.

It is worth noting that the signal line DL8 and the signal line DL11 may be, for example, respectively transferred to different metal layers (for example, the third metal layer M3) via different through holes, and wired to above the signal line DL2 and the signal line DL5 in the first area 110, but the disclosure is not limited thereto. In this regard, a part of the signal line DL2 and a part of the signal line DL8 may overlap in the top view direction, and a part of the signal line DL5 and a part of the signal line DL11 may overlap in the top view direction.

On the side of the first area 110 close to the second area 120, the routing path of the signal line DL9 may be bent to be close to the signal line DL12. In this way, in the first area 110, a part of the signal line DL9 and a part of the signal line DL12 may be disposed between the isolation element K5 and the isolation element K6, and a part of the signal line DL9 and a part of the signal line DL12 may be adjacently disposed. Moreover, the routing configuration manner of the signal line DL9 on the side of the first area 110 close to the second area 120′ may be symmetrical to the routing configuration manner on the side of the first area 110 close to the second area 120, so that the signal line DL9 may be disposed between the signal line DL8 and the signal line DL10 again.

It is worth noting that the signal line DL9 and the signal line DL12 may be, for example, respectively transferred to different metal layers (for example, the third metal layer M3) via different through holes (for example, the through holes C8 and C16), and wired to above the signal line DL3 and the signal line DL6 in the first area 110. In this regard, a part of the signal line DL3 and a part of the signal line DL9 may overlap in the top view direction, and a part of the signal line DL6 and a part of the signal line DL12 may overlap in the top view direction.

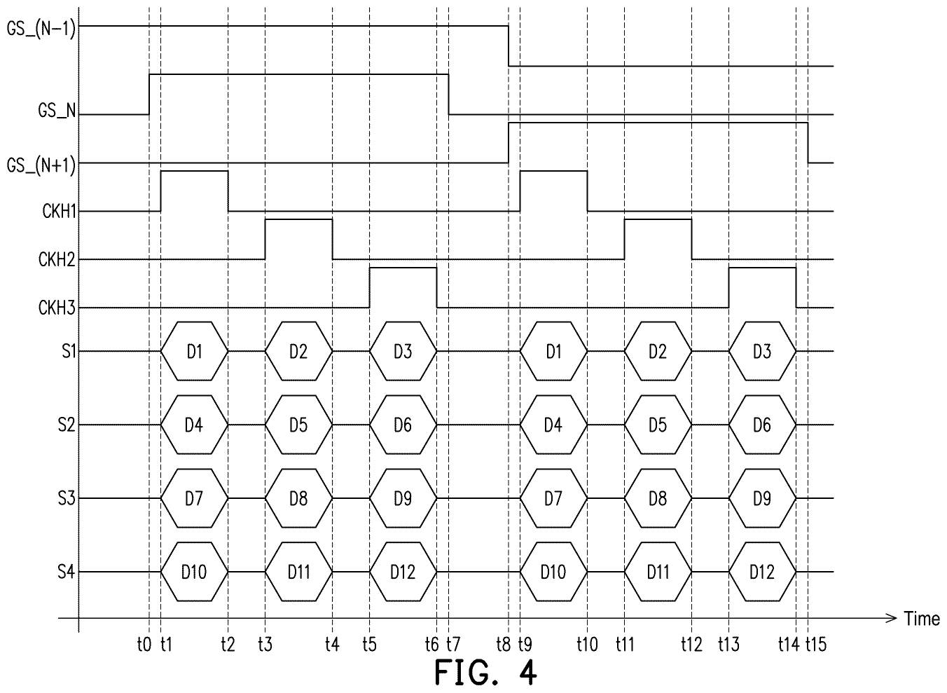

Please refer to FIG. 2 and FIG. 4. In an embodiment, in the first area 110, the signal line DL1 and the signal line DL4 controlled by the same clock signal CKH1 have a first turn-on time period (for example, time t1 to time t2) to respectively transmit the first signal D1 and the second signal D4. The signal line DL1 and the signal line DL4 may be arranged adjacent to each other and may form a first signal line group. The signal line DL2 and the signal line DL5 controlled by the same clock signal CKH2 have a second turn-on time period (for example, time t3 to time t4) to respectively transmit the second signal D2 and the fifth signal D5. The signal line DL2 and the signal line DL5 may be arranged adjacent to each other and may form a second signal line group. The isolation element K1 may be disposed between the first signal line group and the second signal line group. The signal line DL3 and the signal line DL6 controlled by the same clock signal CKH3 have a third turn-on time period (for example, time t5 to time t6) to respectively transmit the third signal D3 and the sixth signal D6. The signal lines DL3 and DL6 may be arranged adjacent to each other and may form a third signal line group. The isolation element K2 may be disposed between the second signal line group and the third signal line group. The signal line DL7 and the signal line DL10 controlled by the same clock signal CKH1 have the first turn-on time period (for example, time t1 to time t2). The signal line DL7 and the signal line DL10 may be arranged adjacent to each other and may form a fourth signal line group. The isolation element K3 may be disposed between the third signal line group and the fourth signal line group. The signal line DL8 and the signal line DL11 controlled by the same clock signal CKH2 have the second turn-on time period (for example, time t3 to time t4), may be arranged adjacent to each other, and may form a fifth signal line group. The isolation element K4 may be disposed between the fourth signal line group and the fifth signal line group. The signal line DL9 and the signal line DL12 are controlled by the same clock signal CKH3. The signal line DL9 and the signal line DL12 have the third turn-on time period (for example, time t5 to time t6). The signal line DL9 and the signal line DL12 may be arranged adjacent to each other and may form a sixth signal line group. The isolation element K5 may be disposed between the fifth signal line group and the sixth signal line group. By analogy, the isolation element K5 may be disposed between the sixth signal line group and the next signal line.

In an embodiment, the first turn-on time period (for example, time t1 to time t2), the second turn-on time period (for example, time t3 to time t4), and the third turn-on time period (for example, time t5 to time t6) are different from each other, but not limited thereto. For example, the start time (for example, time t1) of the first turn-on time period is earlier than the start time (for example, time t3) of the second turn-on time period, and the start time (for example, time t3) of the second turn-on time period is earlier than the start time (for example, time t5) of the third turn-on time period, but not limited thereto.

In the embodiment, the isolation elements K1 to K6 may be conductive elements or insulating elements. If the isolation elements K1 to K6 are conductive elements, the isolation elements K1 to K6 may receive a reference voltage (Vcom), a ground voltage (GND), or signals other than a display data signal, but the disclosure is not limited thereto. In addition, the isolation element has a linear or striped appearance, and the isolation element may be disposed in the same metal layer as adjacent signal lines and may be transferred via a through hole to extend into another metal layer. Specifically, for example, the isolation elements K1 to K3 may be disposed in the second metal layer M2. On the other hand, the isolation elements K4 to K6 may be first disposed in the second metal layer M2, and then respectively transferred via the through holes C7, C9, and C17 to extend into the first metal layer M1. Moreover, a part of the isolation elements K1 and K4 in the first area 110 may overlap in the top view direction (that is, the Z-axis direction), a part of the isolation elements K2 and K5 in the first area 110 may overlap in the top view direction, a part of the isolation elements K3 and K6 in the first area 110 may overlap in the top view direction, and a part of the isolation elements K1 and K4 may overlap in the top view direction (that is, Z-axis direction), but the disclosure is not limited thereto.

In addition, in an embodiment, the second area 120 as shown in FIG. 2 includes a first reference line f1, and the first area 110 includes a second reference line f2, wherein the direction of the first reference line f1 is parallel to an in-plane gate line, and the direction of the second reference line f2 is perpendicular to the in-plane gate line. Under the condition that the first reference line f1 and the second reference line f2 are of equal length, the number of signal lines crossed by the second reference line f2 on the actual substrate is higher than or equal to the number of signal lines crossed by the first reference line f1 on the actual substrate, so it can be seen that the signal line arrangement in the first area 110 is more rigorous than the data arrangement in the second area 120, so as to shrink the non-display area, so that the utilization of the display surface of the display device can be maximized.

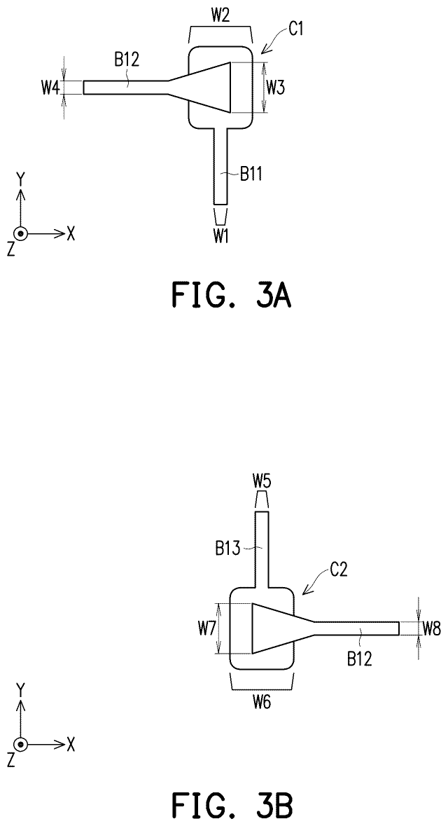

FIG. 3A and FIG. 3B are line width schematic diagrams of a signal line according to an embodiment of the disclosure. Referring to FIG. 2 and FIG. 3A, taking the signal line DL4 of FIG. 2 as an example, the first part B11 of the signal line DL4 is transferred to the second part B12 of the signal line DL4 via the through hole C1. The signal line DL4 located in the second area 120 has a width W1. The first part B11 at the terminal of the signal line DL4 connected to the through hole C1 has a width W2. The width W2 is greater than or equal to the width W1.

In addition, the second part B12 at the other terminal of the signal line DL4 connected to the through hole C1 has a width W3, and there is a minimum width W4 in the second part B12. The width W3 is greater than or equal to the minimum width W4.

Referring to FIG. 2 and FIG. 3B, taking the signal line DL4 of FIG. 2 as an example, the second part B12 of the signal line DL4 is transferred to the third part B13 of the signal line DL4 via the through hole C2. The third part B13 of the signal line DL4 has a width W5. The third part B13 at the terminal of the signal line DL4 connected to the through hole C2 has a width W6. The width W6 is greater than or equal to the width W1. In addition, the second part B12 at the other terminal of the signal line DL4 connected to the through hole C2 has a width W7, and there is a minimum width W8 in the second part B12. The width W7 is greater than or equal to the minimum width W8. By analogy, the implementation manner of line widths of signal lines in paths for realizing layer transfer of other signal lines may be implemented as shown in FIG. 3A and FIG. 3B, which can improve the efficiency of alignment and the yield of line conduction during the manufacturing process.

FIG. 4 is a signal timing diagram according to an embodiment of the disclosure. Referring to FIG. 2 and FIG. 4, in the embodiment, the signal lines SL1 to SL4 may receive the data signals S1 to S4. The gate line GL_N may receive a gate control signal GS_N, and the gate line GL_(N+1) may receive a gate control signal GS_(N+1). The clock signals CKH1 to CKH3 may conduct different switching units (ST1 to ST12) in a time-sharing manner. However, the numbers of clock signals, gate control signals, and data signals used by the display device of the disclosure are not limited to as shown in FIG. 4, and the number of display data is also not limited to as shown in FIG. 4.

Specifically, during a period from time t0 to time t7, the gate control signal GS_N switches from a low voltage level to a high voltage level to conduct the switching units T13 to T24. During a period from time t1 to time t2, the clock signal CKH1 switches from a low voltage level to a high voltage level to conduct the switching units ST1, ST4, ST7, and ST10. Therefore, the signal lines DL1, DL4, DL7, and DL10 may respectively transmit display data D1, D4, D7, and D10 of the data signals S1 to S4 provided by the signal lines SL1 to SL4, and drive the pixel units P13, P16, P19, and P22. During a period from time t2 to time t3, the clock signal CKH2 switches from a low voltage level to a high voltage level to conduct the switching units ST2, ST5, ST8, and ST11. Therefore, the signal lines DL2, DL5, DL8, and DL11 may respectively transmit display data D2, D5, D8, and D11 of the data signals S1 to S4 provided by the signal lines SL1 to SL4, and drive the pixel units P14, P17, P20, and P23. During a period from time t4 to time t5, the clock signal CKH3 switches from a low voltage level to a high voltage level to conduct the switching units ST3, ST6, ST9, and ST12. Therefore, the signal lines DL3, DL6, DL9, and DL12 may respectively transmit display data D3, D6, D9, and D12 of the data signals S1 to S4 provided by the signal lines SL1 to SL4, and drive the pixel units P15, P18, P21, and P24.

During a period from time t8 to time t15, the gate control signal GS_(N+1) switches from a low voltage level to a high voltage level to conduct the switching units T1 to T12. During a period from time t9 to time t10, the clock signal CKH1 switches from a low voltage level to a high voltage level to conduct the switching units ST1, ST4, ST7, and ST10. Therefore, the signal lines DL1, DL4, DL7, and DL10 may respectively transmit display data D1, D4, D7, and D10 of the data signals S1 to S4 provided by the signal lines SL1 to SL4, and drive the pixel units P1, P4, P7, and P10. During a period from time ti1 to time ti2, the clock signal CKH2 switches from a low voltage level to a high voltage level to conduct the switching units ST2, ST5, ST8, and ST11. Therefore, the signal lines DL2, DL5, DL8, and DL11 may respectively transmit display data D2, D5, D8, and D11 of the data signals S1 to S4 provided by the signal lines SL1 to SL4, and drive the pixel units P2, P5, P8, and Pi1. During a period from time ti3 to time ti4, the clock signal CKH3 switches from a low voltage level to a high voltage level to conduct the switching units ST3, ST6, ST9, and ST12. Therefore, the signal lines DL3, DL6, DL9, and DL12 may respectively transmit display data D3, D6, D9, and D12 of the data signals S1 to S4 provided by the signal lines SL1 to SL4, and drive the pixel units P3, P7, P10, and P12.

In addition, in another embodiment, the display device may further include another gate line transmitting a gate control signal GS_(N−1), wherein the gate control signal GS_(N−1) may switch from a low voltage level to a high voltage level at time t0 to conduct multiple switching units in the corresponding column, but the disclosure is not limited thereto.

In the embodiment, during a period of driving the pixel units P1 to P24, although the routing spacing of the part of the signal lines DL1 to DL12 in the first area 110 is reduced, through the reconfiguration of the routing sequence and the setting of the isolation elements K1 to K6, the influence of signal coupling between the signal lines DL1 to DL12 can be effectively reduced.

Specifically, during a period of respectively driving the pixel units P1, P4, P7, P10, P13, P16, P19, and P22, since the part of the signal lines DL1, DL4, DL7, and DL10 in the first area 110 may be adjacently disposed and isolated from other signal lines through the isolation element, the influence of signal coupling from other signal lines (data is not written to the other signal lines during this period) on the signal lines DL1, DL4, DL7, and DL10 can be reduced during the period of simultaneously transmitting the display data D1, D4, D7, and D10 based on the clock signal CKH1. During a period of respectively driving the pixel units P2, P5, P8, P11, P14, P17, P20, and P23, since the part of the signal lines DL2, DL5, DL8, and DL11 in the first area 110 may be adjacently disposed and isolated from other signal lines through the isolation element, the influence of signal coupling from other signal lines (data is not written to the other signal lines during this period) on the signal lines DL2, DL5, DL8, and DL11 can be reduced during the period of simultaneously transmitting the display data D2, D5, D8, and D11 based on the clock signal CKH2. During a period of respectively driving the pixel units P3, P6, P9, P12, P15, P18, P21, and P24, since the part of the signal lines DL3, DL6, DL9, and DL12 in the first area 110 may be adjacently disposed and isolated from other signal lines through the isolation element, the influence of signal coupling from other signal lines (data is not written to the other signal lines during this period) on the signal lines DL3, DL6, DL9, and DL12 can be reduced during the period of simultaneously transmitting the display data D3, D6, D9, and D12 based on the clock signal CKH3.

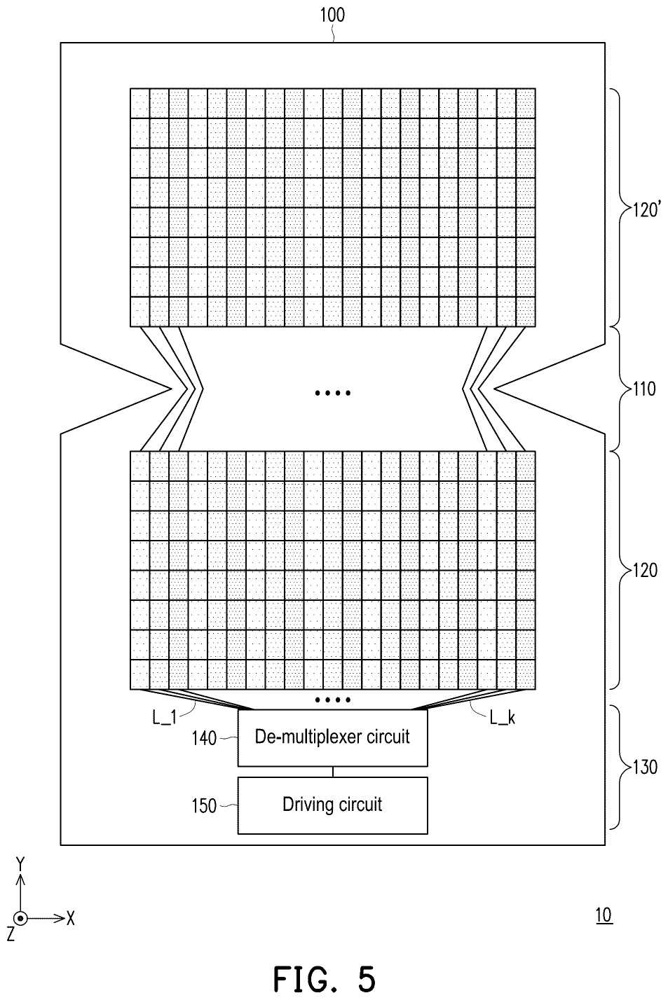

FIG. 5 is a schematic diagram of a display device according to another embodiment of the disclosure. Referring to FIG. 5, the display device 10 includes the substrate 100. The substrate 100 includes the first area 110, the second areas 120 and 120′, and the third area 130. The first area 110 is located between the second area 120 and the second area 120′, and the minimum width of the first area 110 in the X-axis direction is smaller than the minimum widths of the second areas 120 and 120′. The third area 130 is located below the second area 120. The third area 130 may be provided with a de-multiplexer circuit 140 and a driving circuit 150. The driving circuit 150 may send signals to multiple signal lines L_1 to L_k in the second areas 120 and 120′ and the first area 110 via the de-multiplexer circuit 140, where k is a positive integer. In another embodiment of the disclosure, the substrate 100 of the display device 10 may have other irregular shapes. In this regard, in a display area with an irregular shape, for example, the routing configuration manner of the signal lines at where the width of the first area 110 in the X-axis direction decreases may be implemented by adopting the routing configuration manner (for example, the manners of winding, layer transfer, and setting isolation elements of FIG. 2) of each of the above embodiments. In this way, the influence of signal coupling between the signal lines at where a part of the routing space decreases can be effectively reduced.

In addition, in another embodiment, the arrangement manner of multiple pixels in the second areas 120 and 120′ along the X-axis direction may be red pixels, green pixels, and blue pixels, but the disclosure is not limited thereto. In another embodiment (not shown), the arrangement manner of multiple pixels in the second areas 120 and 120′ along the X-axis direction may also be red pixels, green pixels, blue pixels, and green pixels. Alternatively, multiple pixels in the second areas 120 and 120′ may also be regularly, irregularly, or semi-irregularly arranged.

In summary, the display device of the disclosure may be configured through special routing in the hole border area of the hole frame, in conjunction with the design of the isolation elements, so that signal coupling interference between the signal lines passing through the hole border area of the hole frame can be effectively reduced. Therefore, the display device of the disclosure can provide a good display effect.

Finally, it should be noted that the above embodiments are only configured to illustrate, but not to limit, the technical solutions of the disclosure. Although the disclosure has been described in detail with reference to the above embodiments, persons skilled in the art should understand that the technical solutions described in the above embodiments may still be modified or some or all of the technical features thereof may be equivalently replaced. However, the modifications or replacements do not cause the essence of the corresponding technical solutions to deviate from the scope of the technical solutions of the embodiments of the disclosure.

What is claimed is:

1. A display device, comprising:
a substrate, having a first area and a second area, wherein the second area surrounds the first area;
a first signal line, a second signal line, and a third signal line, disposed on the substrate, respectively extending from the second area to the first area, and respectively configured to transmit a first signal, a second signal, and a third signal in a time-sharing manner; and
a plurality of isolation elements, disposed in the first area,
wherein the first signal and the second signal respectively have a first turn-on time period, and the third signal has a second turn-on time period, wherein the first turn-on time period is different from the second turn-on time period,
wherein in the second area, the third signal line is disposed between the first signal line and the second signal line,
wherein in the first area, the second signal line is disposed between the first signal line and the third signal line, and one of the isolation elements is disposed between the second signal line and a part of the third signal line.

2. The display device according to claim 1, wherein the first signal line and the second signal line respectively comprise a first part, a second part, and a third part, wherein the second part is connected between the first part and the third part.

3. The display device according to claim 2, wherein in a top view direction, the second part of the first signal line and the second part of the second signal line are separated from each other.

4. The display device according to claim 2, wherein extension directions of a part of the second part and a part of the first part are perpendicular to each other.

5. The display device according to claim 2, wherein the first part and the second part are located in different layers, and the second part and the third part are located in different layers.

6. The display device according to claim 5, wherein the substrate comprises a first metal layer, a second metal layer, and a third metal layer.

7. The display device according to claim 6, wherein an insulating layer and a plurality of through holes are further disposed between any two adjacent layers of the first metal layer, the second metal layer, and the third metal layer.

8. The display device according to claim 6, wherein the isolation elements are disposed in a same metal layer in the second area.

9. The display device according to claim 6, wherein a part of the isolation elements are disposed in at least two of the first metal layer, the second metal layer, and the third metal layer in the first area, and overlap in a top view direction.

10. The display device according to claim 1, further comprising:
a plurality of sub-pixels, disposed in the second area of the substrate, wherein the second signal line is electrically connected to a part of the sub-pixels, and the third signal line is electrically connected to another part of the sub-pixels.

11. The display device according to claim 10, wherein the part of the sub-pixels and the another part of the sub-pixels are sub-pixels of a same color.

12. The display device according to claim 1, wherein in the second area of the substrate, a part of the third signal line is disposed between a part of the first signal line and a part of the second signal line, and in the first area of the substrate, the second signal line is disposed between the first signal line and the third signal line.

13. The display device according to claim 1, wherein the isolation elements comprise conductive elements.

14. The display device according to claim 1, wherein the isolation elements comprise insulating elements.

15. The display device according to claim 1, wherein the substrate further has a third area, and the third area is provided with a de-multiplexer circuit, wherein the de-multiplexer circuit is electrically connected to the first signal line, the second signal line, and the third signal line.

16. The display device according to claim 1, wherein a minimum width of the first area of the substrate in a first direction is smaller than a minimum width of the second area of the substrate in the first direction.

17. The display device according to claim 1, wherein a setting sequence of the first signal line, the second signal line, and the third signal line in the first area is different from a setting sequence in the second area.

18. The display device according to claim 1, wherein a routing space of the first area is smaller than a routing space of the second area.

19. The display device according to claim 1, wherein the first area comprises a hole and a hole border area.

20. The display device according to claim 1, wherein the first signal, the second signal, and the third signal are respectively data signals.
